(19) United States
(12) Patent Application Publication
(10) Pub. No.: US 2019/0188740 A1
(43) Pub. Date: Jun. 20, 2019

(54) CONTENT DELIVERY OPTIMIZATION USING EXPOSURE MEMORY PREDICTION

(71) Applicant: Facebook, Inc., Menlo Park, CA (US)

(72) Inventors: Hongzheng Xiong, London (GB); Pravin Paratey, Greenford (GB); Brian Rosenthal, Mountain View, CA (US); Abhishek Agarwal, London (GB); Daniel Kristopher Harvey, London (GB); Damien Lefortier, London (GB)

(21) Appl. No.: 15/849,364

(22) Filed: Dec. 20, 2017

(51) Int. Cl. G06Q 30/02; H04L 29/08; G06F 15/18

(52) U.S. Cl. CPC G06Q 30/0203; H04L 67/306; G06Q 30/0254; G06Q 30/0201; G06F 15/18

(57) ABSTRACT

An online system displays a first set of content items to a user of a test group and displays a second set of content items to a user of a control group. The online system presents a poll to each user to evaluate the user's recall of the content item associated with the poll. The online system receives a poll response from each user, which is input, along with a set of features associated each user, into a prediction model. The prediction model enables the online system to determine a poll response prediction of a third user based on a set of features associated with the third user. The poll response prediction enables the online system to determine if it would be effective to present the content item to the third user.

### BACKGROUND

This disclosure relates generally to online systems, and more specifically to models for presenting content items to users of an online system, such as a social networking system.

Online services, such as online systems, search engines, news aggregators, Internet shopping services, and content delivery services, have become a popular venue for presenting content items to prospective buyers. Content providers may provide content campaigns that aim to promote awareness of a content item. Some content campaigns increase exposure of a brand to users, which may increase a user's interest in the presented product or service. Some campaigns may not require an action from the user and, thus, are typically measured by number of impressions, dwell time of an impression, or number of click-throughs, but may not otherwise solicit a direct response. Since these campaigns may not require an action from a user, an online service may not be able to optimize presentation of content items of the campaign based on a user's interactions with the content items, which may make it difficult to determine the effectiveness of the campaign. Specifically, evaluating a user's recall of a content item of the campaign after the user has been presented the content item can be difficult.

### SUMMARY

An online system uses machine learning techniques to predict a user's recall of a content item and improve content delivery to users. The online system displays a first set of content items to a user of a test group and displays a second set of content items to a user of a control group. The online system presents a poll to the user of the test group and to the user of the control group to evaluate each user's recall of a content item. The content item associated with the poll has been previously presented to the user of the test group but not to the user of the control group. The poll poses a question to each user regarding if the user remembers seeing the content item or enjoyed seeing the content item. The online system receives a poll response from each user, wherein each poll response indicates the user's recall of the content item. The online system can determine whether or not each user has true recall or false recall of the content item. The poll response of each user, along with a set of features associated each user, are input into a prediction model to update and improve the accuracy of the prediction model. The online system may input a set of features associated with a third user into the prediction model, which outputs a poll response prediction of the third user. The poll response prediction indicates how the third user would respond to the poll if the third user had been presented the content item associated with the poll and had been presented the poll. In some embodiments, the poll response prediction may be associated with a confidence level. The poll response prediction enables the online system to determine if the third user is likely to remember the content item if it was presented to the third user and, thus, if it would be effective to present the content item to the third user. Based on the poll response prediction, the online system delivers or prevents delivery of the content item to the third user.

### BRIEF DESCRIPTION OF THE DRAWINGS

FIG. 1 is a block diagram of a system environment in which an online system operates, in accordance with an embodiment.

FIG. 2 is a block diagram of an architecture of the online system, in accordance with an embodiment.

FIG. 3 is a block diagram of a poll response prediction module, in accordance with an embodiment.

FIG. 4 is an example data flow chart for using a test group and a control group to update a poll response prediction model, in accordance with an embodiment.

FIG. 5 is a flowchart illustrating a process of predicting a poll response of a user, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

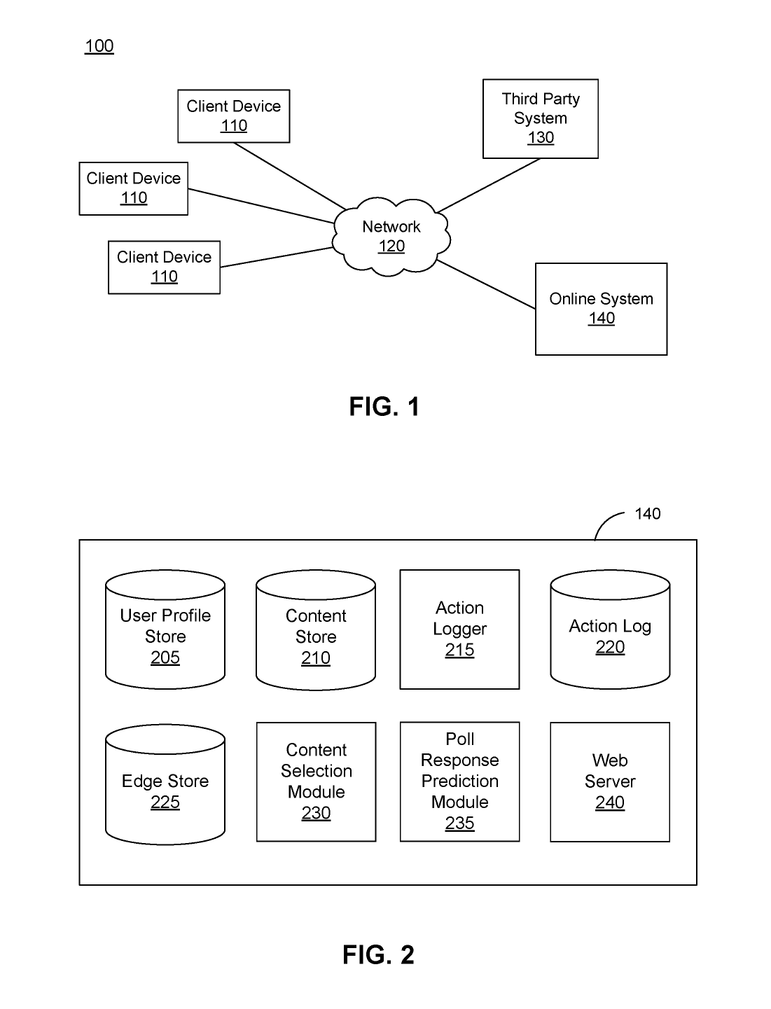

FIG. 1 is a block diagram of a system environment 100 for an online system 140.

The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140, e.g., via a user interface. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, a poll response prediction module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, geographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220. For example, the user profile may store an amount of time that a user spends viewing a content item (i.e., a dwell time) or if a user interacts with content items by clicking on or selecting options associated with the content item (i.e., clickiness).

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

In various embodiments, a content item includes various components capable of being identified and retrieved by the online system 140. Example components of a content item include: a title, text data, image data, audio data, video data, a landing page, a user associated with the content item, or any other suitable information. The online system 140 may retrieve one or more specific components of a content item for presentation in some embodiments. For example, the online system 140 may identify a title and an image from a content item and provide the title and the image for presentation rather than the content item in its entirety.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In various embodiments, the content store 210 includes multiple campaigns, which each include one or more content items. In various embodiments, a campaign is associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 140 provides the online system 140 with various campaigns each including content items having different characteristics (e.g., associated with different content, including different types of content for presentation), and the campaigns are stored in the content store.

Campaigns may be associated with one or more objectives for actions associated with the campaign. An objective describes one or more goals for interactions that an entity associated with a content item desires other users to perform when presented with content included in the content item. Example goals may include: a number of impressions of content included in the campaign desired by an entity associated with the campaign or a number of a particular type of interaction performed by users presented with content of the campaign. An “impression” is an instance in which a content item is presented to a user of the online system 140. In some embodiments, a “dwell time” of the impression may be measured, which indicates the amount of time a user spends with a content item. Types of interactions performed by users on content items may include, but are not limited to, a click-through, a user registration, a sale of a service or product, or any other action defined as valuable to the campaign. Click-throughs may be determined by users who click on the content item, and may also be measured as a “click through rate” describing the ratio of users performing a click per number of impressions. Some of these types of interactions may be considered “conversions,” wherein the user has converted into a customer. A historical conversion rate identifies a percentage or number of online system users performing a conversion when presented with the content.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements and/or content items on the online system 140 as well as with other applications operating on the online system 140. For example, the action log 220 may store a dwell time or a clickiness of the user in association with content items. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140. Edges may connect two users who are connections in a social network, or may connect a user with an object in the system. In one embodiment, the nodes and edges form a complex social network of connections indicating how users are related or connected to each other (e.g., one user accepted a friend request from another user to become connections in the social network) and how a user is connected to an object due to the user interacting with the object in some manner (e.g., “liking” a page object, joining an event object or a group object, etc.). Objects can also be connected to each other based on the objects being related or having some interaction between them.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users. In addition, the number of connections that a user has (i.e., a friend count) may be stored in the user profile store 205 or the edge store 225.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a feed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

The poll response prediction module 235 predicts a user's response to a poll associated with one or more content items. The user's response prediction (also referred to as “poll response prediction” or “predicted poll response”) indicates how a user may have responded to a poll if the poll and the content item associated with the poll had been delivered to the user. In the embodiment of FIG. 2, a poll may evaluate, for example, a user's recall of a specific content item and/or a user's preferences for a content item. For example, a poll may ask if the user remembers or enjoyed seeing the content item. A user's poll response prediction can be used to determine the interests and/or preferences of a user so that suitable content can be identified for future delivery to the user. Typically, a poll typically may be presented to a user in a feed of the user such that the poll is displayed among other content items. However, delivering polls in the feed may be an expensive method for evaluating a user's recall or preferences for a content item since the poll may take the place of a content item associated with a bid amount for which the online system might receive compensation. By predicting a user's response to a poll, the poll response prediction module 235 allows the online system 140 to avoid delivering polls in place of other content items and to minimize the potential for lost compensation. The online system 140 may use the user's response prediction in lieu of an actual poll response from the user, enabling the online system 140 to identify suitable content for future delivery to the user and reserve spaces in the feed for delivery of content items.

The poll response prediction module 235 determines a user's response prediction to a poll using a poll response prediction model. The poll response prediction model receives a set of features associated with a user as input, and based on the set of features, outputs a user's response prediction to the poll. The poll response prediction indicates how a user may have responded to a poll if the poll and the content item associated with the poll had been delivered to the user. A user's poll response prediction may be used to inform the online system 140 whether or not it would be effective to present a content item to a user. For example, if a user's poll response prediction is favorable (i.e., the user would recall or enjoy seeing the content item), then the online system 140 may present the content item to the user. If a user's poll response prediction is not favorable (i.e., the user would not recall or would not enjoy seeing the content item), then the online system 140 may prevent delivery of the content item to the user. In some embodiments, the poll response prediction model may additionally output a confidence level associated with the user's response prediction. In some embodiments, the poll response prediction module 235 may generate the poll response prediction model using historical data of poll responses from other users and features associated with those users. In other embodiments, the poll response prediction module 235 may update an existing prediction model.

The online system 140 may use the poll response prediction model to identify additional opportunities for content delivery. For example, based on a user's response prediction to a poll associated with a content item, the online system 140 may identify similar content items or content items from the same content provider or campaign for delivery to the user. Similarly, the online system 140 may prevent delivery of similar content items or content items from the same content provider or campaign to the user. In some embodiments, a content item may be part of a campaign associated with an objective that indicates a level of recall of a content item. In these embodiments, if a user's poll response prediction indicates that a user would have low recall of a content item, the online system 140 may re-introduce the content item at a later time to improve the user's recall of the content item. In some embodiments, the online system 140 may use the poll response prediction model to identify other users of the online system 140 that have similar features to the user, such that the other users may have a similar poll response prediction to the user.

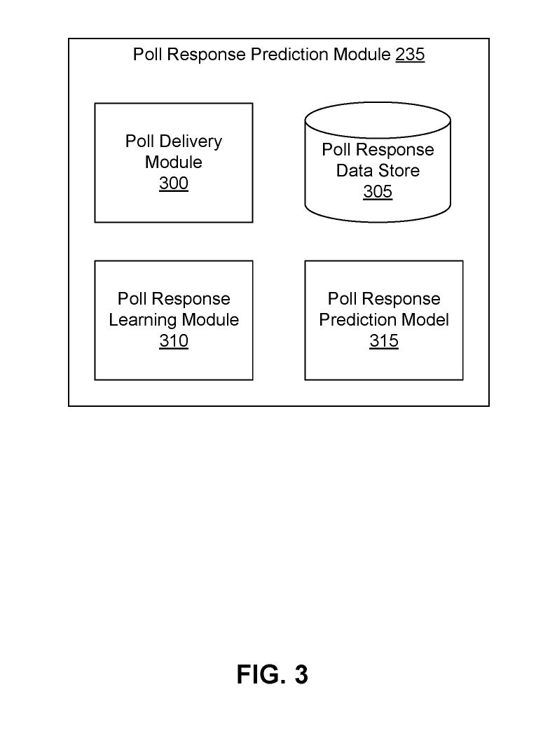

In some embodiments, the online system 140 may use the poll response prediction model to determine patterns in user recall of content items. For example, the online system 140 may determine that delivering content items to users at a certain time of day, on a certain day of the week, on a certain type of client device, in a certain language, or the like improves the likelihood of a user remembering a content item or interacting with a content item. The online system 140 may use these determined patterns to re-introduce content items to users that were predicted to have low recall, thereby improving the recall of those content items by the users. The online system 140 may also use these determined patterns to deliver content items via methods that encourage recall of certain content items. As an example, the online system 140 may encourage recall of content items from trustworthy content providers rather than untrustworthy content providers (e.g., content providers known to be associated with providing and/or propagating “fake news”). The poll response prediction module 235 will be discussed in further detail with regards to FIG. 3.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, or BlackberryOS.

### Poll Response Prediction

FIG. 3 is a block diagram of a poll response prediction module 235, in accordance with an embodiment. The poll response prediction module 235 predicts a user's response to a poll associated with one or more content items. In the embodiment of FIG. 3, the poll response prediction module 235 generates or updates a poll response prediction model using historical data of poll responses given by users that have been presented polls associated with one or more content items. The poll response prediction module 235 shown in FIG. 3 includes a poll delivery module 300, a poll response data store 305, a poll response learning module 310, and a poll response prediction module 315. In other embodiments, the poll response prediction module 235 may include additional, fewer, or different components for various applications. In addition, the components may be arranged differently than described here.

The poll delivery module 300 delivers polls to users of the online system 140. In the embodiment of FIG. 3, a poll may be delivered to a user in a feed of the user. Each poll may be associated with a specific content item, a type of content, a content provider, and/or a campaign. In the embodiment of FIG. 3, the poll delivery module 300 delivers a poll to users of a test group and to users of a control group. The users of the test group have been previously presented the content item associated with the poll, whereas the users of the control group have not been previously presented the content item associated with the poll. By delivering a poll to a test group and to a control group, the poll response prediction module 235 accounts for inherent bias and noise in users' poll responses, which may occur due to false recall of a content item.

The poll response data store 305 stores the poll responses of the users in the test group and the users in the control group. In association with the poll responses, the poll response data store 305 may also store a set of features associated with the respective user, a date and time that the poll was delivered to the user, a language in which the poll was delivered, a type of device on which the poll was delivered, and/or other descriptive information. Features associated with the respective user may include biographic, demographic, and/or geographic information of the user, and other types of descriptive information (e.g., work experience, educational history, gender, hobbies or preferences, location and the like). Features associated with the respective user may also include actions taken by the user, such as a dwell time of the user on the content item associated with the poll if the user was presented the content item, a clickiness of the user on the content item, an average dwell time of the user, and the like. The poll response data store 305 may also store characteristics associated with the poll, such as the content item presented in the poll, a content provider associated with the content item, a type of the content item, a type of device on which the content item was presented to the user, and the like. The poll response data store 305 may be accessed by the poll delivery module 300, the poll response learning module 310, the poll response prediction model 315, and other components of the online system 140.

The poll response learning module 310 applies machine learning techniques to generate a poll response prediction model 315 that when applied to a set of features associated with a user outputs a poll response prediction of a user. The poll response prediction is a prediction of the user's response to a poll if the user had been presented a content item and a poll associated with the content item. The poll response prediction model 315 may additionally output a confidence level associated with the poll response prediction. The poll response prediction may vary depending on the type of poll and the possible responses to the poll.

As part of the generation of the poll response prediction model 315, the poll response learning module 310 forms a training set of users from the test group and/or the control group by identifying a positive training set of users that have been determined as having true recall of the content item associated with the delivered poll (i.e., the user was presented or was not presented the content item of the poll and selected a poll response indicating that the user, respectively, remembered or did not remember seeing the content item), and, in some embodiments, forms a negative training set of users that have been determined as having false recall of the content item associated with the poll (i.e., the user was presented or was not presented the content item and selected a poll response indicating that the user, respectively, did not remember or falsely remembered seeing the content item).

The poll response learning module 310 extracts feature values from the users of the training set, the features being variables deemed potentially relevant to the type of poll response given by the user in response to the delivered poll. Specifically, the feature values extracted by the poll response learning module 310 include biographic, demographic, and/or geographic information of the user, interests and preferences of the user, actions associated with the user (types of interactions with content items, a dwell time, a clickiness, etc.), features associated with the delivery of the poll to the user (a date and time, a language, a type of device, etc.), features associated with the poll itself (content item, type of content item, content provider, type of content provider, etc.). These features may be determined from the action log 220, the edge store 225, and/or the poll response data store 305. An ordered list of the features for a user is herein referred to as the feature vector for the user. In one embodiment, the poll response learning module 310 applies dimensionality reduction (e.g., via linear discriminant analysis (LDA), principle component analysis (PCA), or the like) to reduce the amount of data in the feature vectors for users to a smaller, more representative set of data.

The poll response learning module 310 uses supervised machine learning to train the poll response prediction model 315, with the feature vectors of the positive training set and the negative training set serving as the inputs. Different machine learning techniques—such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps—may be used in different embodiments. The poll response prediction model 315, when applied to the feature vector of a user, outputs a poll response prediction of the user.

In some embodiments, a validation set is formed of additional users, other than those in the training sets, which have already been presented a poll and have given a response to the poll. The poll response learning module 310 applies the trained validation poll response prediction model 315 to the users of the validation set to quantify the accuracy of the poll response prediction model 315. Common metrics applied in accuracy measurement include: Precision=TP/(TP+FP) and Recall=TP/(TP+FN), where precision is how many the poll response prediction model 315 correctly predicted (TP or true positives) out of the total it predicted (TP+FP or false positives), and recall is how many the poll response prediction model 315 correctly predicted (TP) out of the total number of users that have provided poll responses (TP+FN or false negatives). The F score (F-score=2*PR/(P+R)) unifies precision and recall into a single measure. In one embodiment, the poll response learning module 310 iteratively re-trains the poll response prediction model 315 until the occurrence of a stopping condition, such as the accuracy measurement indication that the model is sufficiently accurate, or a number of training rounds having taken place.

The poll response prediction model 315 outputs a poll response prediction of a user based on the feature vector of the user. The online system 140 may beneficially use the user's poll response prediction to determine if it would be effective to deliver the content item associated with the poll to the user and also to identify suitable content for future delivery to the user. As described with regards to FIG. 2, the online system 140 may use the user's poll response prediction to deliver or prevent delivery of certain content items to the user. The poll response prediction model 315 may additionally be used to encourage or improve recall of certain content items.

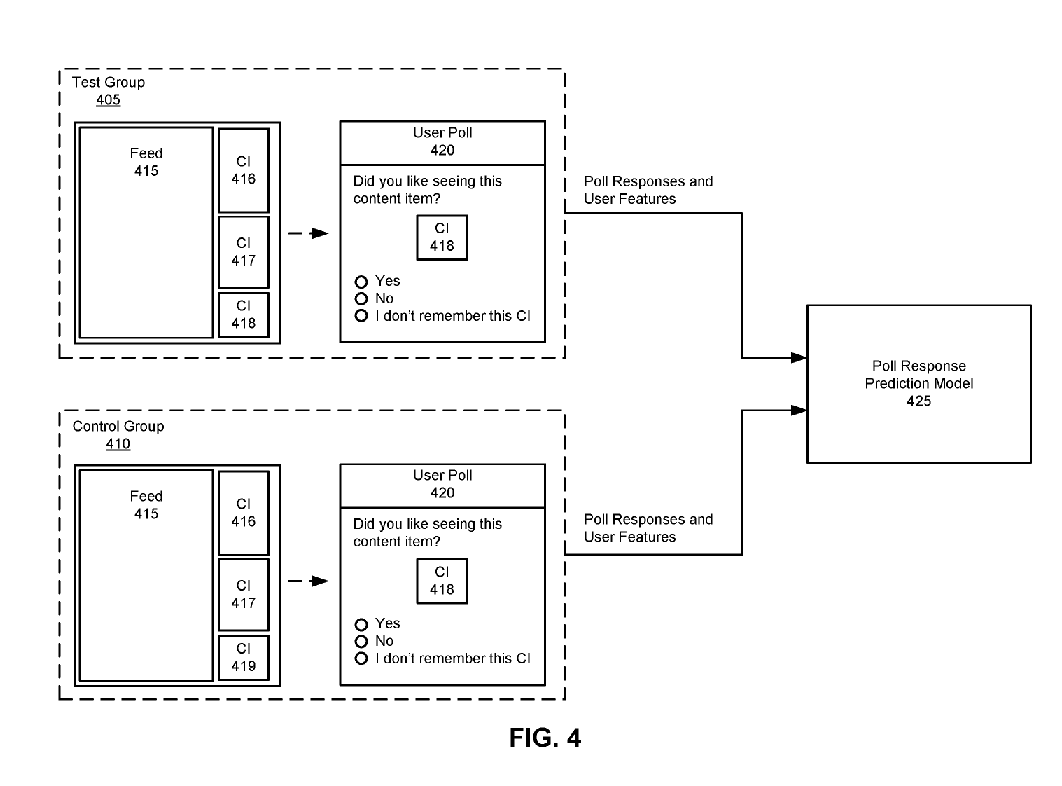

FIG. 4 is an example data flow chart 400 for using a test group 405 and a control group 410 to update a poll response prediction model 425, in accordance with an embodiment. The data flow chart 400 shown in FIG. 4 illustrates a respective news feed and a poll that are delivered to the test group 405 and to the control group 410. The poll response and user features of each user in the test group 405 and of each user in the control group 410 are input into the poll response prediction model 425. The poll response prediction model 425 may be an embodiment of the poll response prediction model 315. As previously described, the test group 405 includes users that have been previously presented a content item associated with a poll delivered to the user, and the control group 410 includes users that have not been previously presented the content item associated with the poll delivered to the user. By polling a test group and a control group, the online system 140 accounts for inherent bias and noise in users' poll responses.

As illustrated in FIG. 4, users of the test group 405 are presented a feed 415, which may display content items from the online system 140. The users are additionally presented one or more other content items (CI), such as content item 416, content item 417, and content item 418. After the content items 416, 417, 418 have been viewed by the user, the online system 140 may present a user poll 420, which poses a question to the user, “Did you like seeing this content item?” In the embodiment of FIG. 4, the user poll 420 displays a content item, such as content item 418, that the user of the test group 405 has previously been presented. In some embodiments, the user poll 420 may not re-display the content item associated with the poll. In these embodiments, the language of the posed question may include context or a reference to the specific content item. The user poll 420 offers three poll responses: “Yes,” “No,” and “I don't remember this content item.” The user of the test group 405 may respond to the user poll 420 by selecting one of the three responses. The “Yes” and “No” responses indicate that the user remembers being presented the content item 418, and the online system 140 may learn more about the user's interests and preferences from the responses. The “I don't remember this content item” response indicates that the user does not remember being presented the content item 418, which may indicate that the content item was not memorable to the user and, thus, is not interesting to the user. The online system 140 may extract features associated with the user, which may include biographic, demographic, and/or geographic information of the user, interests and preferences of the user, actions associated with the user (types of interactions with content items, a dwell time, a clickiness, etc.), features associated with the delivery of the poll to the user (a date and time, a language, a type of device, etc.), features associated with the poll itself (content item, type of content item, content provider, type of content provider, etc.). The poll response of the user and extracted features are input into the poll response prediction model 425 to update the poll response prediction model 425. The poll responses of the users in the test group 405 allow the online system 140 to evaluate a user's preferences and recall of a content item and improve the accuracy of the poll response prediction model 425. In other embodiments, the poll question and poll responses may vary. For example, a poll may ask if the user remembers being presented the content item, if the user would like more information on the content item, if the user would like to see similar content items, if the content item is relevant to the user, and the like.

Similarly, users of the control group 410 are presented a feed 415 and one or more other content items (CI), such as content item 416, content item 417, and content item 419. After the content items 416, 417, 419 have been viewed by the user, the online system 140 may present the user poll 420. In the embodiment of FIG. 4, the test group 405 and the control group 410 are presented the same user poll. However, users of the control group 410 have not previously been presented the content item 418 associated with the user poll 420. The user of the control group 410 may respond to the user poll 420 by selecting one of the three responses: “Yes,” “No,” “I don't remember this content item.” The “Yes” and “No” responses indicate that the user falsely remembers being presented the content item 418, and the “I don't remember this content item” response indicates that the user correctly does not recall seeing the content item 418. The poll response of the user and extracted features of the user are input into the poll response prediction model 425 to update the poll response prediction model 425 and improve the accuracy of the poll response prediction model 425.

Evaluating the poll responses of users in the test group 405 and the control group 410 enables the online system 140 to account for a variety of factors, such as inherent bias, false recall of a content item, delivery method of the content items, etc. For each poll response, the online system 140 may determine if the poll response is associated with a user having true recall or false recall of a content item. In this configuration, the online system 140 improves the accuracy of the poll response prediction model 425, such that accurate poll response predictions can be determined for other users of the online system 140. Accurate poll response predictions allow the online system 140 to serve better content to users while minimizing the need to deliver polls to users.

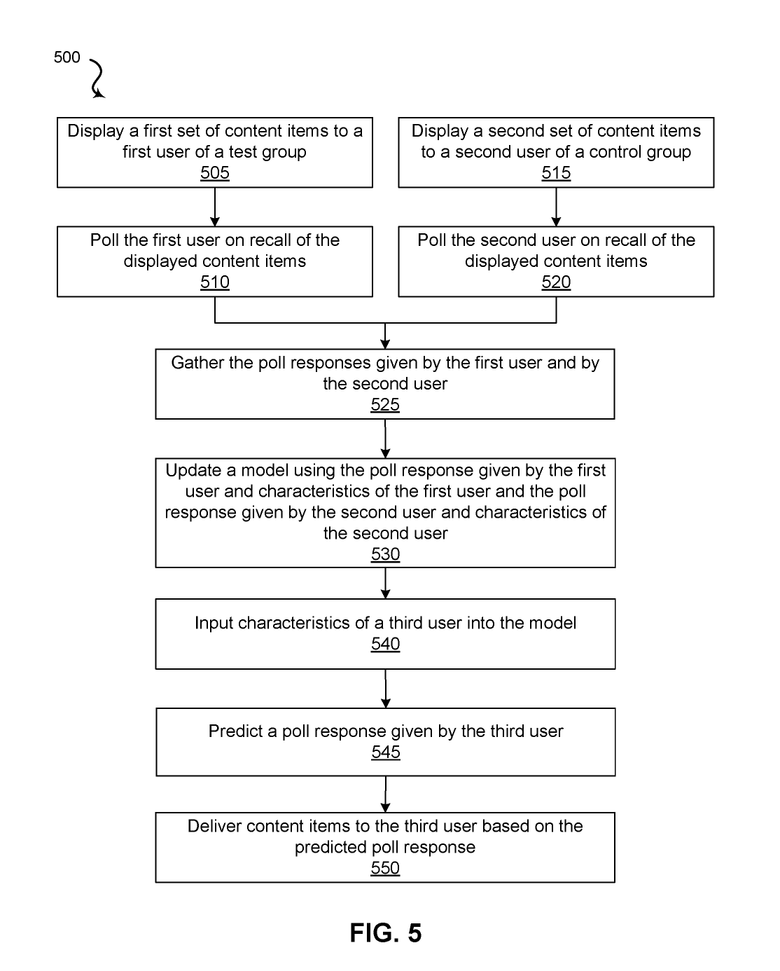

FIG. 5 is a flowchart illustrating a process 500 of predicting a poll response of a user to deliver content to the user, in accordance with an embodiment. The process 500 shown in FIG. 5 is performed by the online system 140 and may use data received from the third party system 130.

The online system 140 displays 505 a first set of content items to a first user of a test group. After the first user views the first set of content items, the online system 140 polls 510 the first user on recall of the displayed content items by presenting a poll that is associated with one or more of the content items of the first set. The poll may ask the first user if the user remembers seeing one or more of the content items of the first set. The first user may select a poll response presented in the poll, indicating whether or not the first user remembers seeing the one or more content items. Additionally, the online system 140 displays 515 a second set of content items to a second user of a control group. In the embodiment of FIG. 5, the second set of content items does not include one or more content items that are included in the first set of content items and are associated with the poll. After the second user views the second set of content items, the online system 140 polls 520 the second user on recall of the displayed content items by presenting the poll that is associated with one or more content items of the first set. The second user may select a poll response presented in the poll, indicating whether or not the second user remembers seeing the one or more content items. In other embodiments, content items may be displayed and the poll may be delivered to the control group before the test group or simultaneously.

The online system 140 gathers 525 the poll responses given by the first user and by the second user. The online system 140 may evaluate the poll responses to determine if users had true recall or false recall of the one or more content items associated with the poll. The online system 140 updates 530 the model using the poll response given by the first user and characteristics of the first user and the poll response given by the second user and characteristics of the second user. The model is an embodiment of the poll response prediction model 315 or poll response prediction model 425.

The online system 140 inputs 540 characteristics of a third user into the model. Based on the characteristics of the third user, the model predicts 545 a poll response given by the third user 545. The predicted poll response indicates whether or not the third user would recall the one or more content items associated with the poll. If the predicted poll response indicates that the third user would recall the one or more content items associated with the poll, the online system 140 delivers 550 the one or more content items to the third user based on the predicted poll response. In some embodiments, the online system 140 may additionally deliver content items that are related (e.g., based on type of content item, content provider, type of content provider, and the like) to the one or more content items associated with the poll. If the predicted poll response indicates that the third user would not recall the one or more content items associated with the poll, the online system 140 would prevent delivery of the one or more content items to the user. In some embodiments, the online system 140 may additionally prevent delivery of content items that are related (e.g., based on type of content item, content provider, type of content provider, and the like) to the one or more content items associated with the poll.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
displaying, via the user interface, a first set of content items to a first user of an online system;
displaying, via the user interface, a second set of content items to a second user of the online system;
presenting, via the user interface, a poll to the first user and the poll to the second user, wherein the poll evaluates a user's recall of at least one content item and wherein the poll is associated with at least one content item included in the first set that is not included in the second set;
receiving, via the user interface, a poll response from the first user and a poll response from the second user;
updating a prediction model based on the poll response from the first user and a set of features associated with the first user and based on the poll response from the second user and a set of features associated with the second user;
predicting, using the prediction model and a set of features associated with the third user, a poll response of a third user;
delivering, based on the predicted poll response of the third user, the at least one content item associated with the poll to the third user.

2. The method of claim 1, further comprising delivering additional content items to the third user that are related to the at least one content item associated with the poll.

3. The method of claim 1, further comprising, based on the predicted poll response of the third user, preventing the delivery of the at least one content item associated with the poll to the third user.

4. The method of claim 3, further comprising, based on the predicted poll response of the third user, preventing the delivery of additional content items to the third user that are related to the at least one content item associated with the poll.

5. The method of claim 1, wherein the poll response indicates a user's recall of the at least one content item associated with the poll.

6. The method of claim 1, wherein the predicted poll response is associated with a confidence level.

7. The method of claim 1, wherein the set of features associated with the first user, the second user, and the third user include one or more of the following: biographic information, demographic information, geographic information, interests of the user, preferences of the user, interactions associated with content items, features associated with the delivery of the poll, and features associated with the poll.

8. The method of claim 1, further comprising, using the prediction model, determining a delivery method of the at least one content item, wherein the delivery method specifies one or more of the following: a day of the week, a time period in a day, a type of client device, and a language.

9. A computer program product comprising a computer-readable storage medium containing computer program code for:
displaying, via a user interface, a first set of content items to a first user of an online system;
displaying, via the user interface, a second set of content items to a second user of the online system;
presenting, via the user interface, a poll to the first user and the poll to the second user, wherein the poll evaluates a user's recall of at least one content item and wherein the poll is associated with at least one content item included in the first set that is not included in the second set;
receiving, via the user interface, a poll response from the first user and a poll response from the second user;
updating a prediction model based on the poll response from the first user and a set of features associated with the first user and based on the poll response from the second user and a set of features associated with the second user;
predicting, using the prediction model and a set of features associated with the third user, a poll response of a third user;
delivering, based on the predicted poll response of the third user, the at least one content item associated with the poll to the third user.

10. The computer program product of claim 9, further comprising computer program code for delivering additional content items to the third user that are related to the at least one content item associated with the poll.

11. The computer program product of claim 9, further comprising computer program code for, based on the predicted poll response of the third user, preventing the delivery of the at least one content item associated with the poll to the third user.

12. The computer program product of claim 11, further comprising computer program code for, based on the predicted poll response of the third user, preventing the delivery of additional content items to the third user that are related to the at least one content item associated with the poll.

13. The computer program product of claim 9, wherein the poll response indicates a user's recall of the at least one content item associated with the poll.

14. The computer program product of claim 9, wherein the predicted poll response is associated with a confidence level.

15. The computer program product of claim 9, wherein the set of features associated with the first user, the second user, and the third user include one or more of the following: biographic information, demographic information, geographic information, interests of the user, preferences of the user, interactions associated with content items, features associated with the delivery of the poll, and features associated with the poll.

16. The computer program product of claim 9, further comprising computer program code for, using the prediction model, determining a delivery method of the at least one content item, wherein the delivery method specifies one or more of the following: a day of the week, a time period in a day, a type of client device, and a language.
